(19) United States
(12) Patent Application Publication
(10) Pub. No.: US 2026/0236776 A1
(43) Pub. Date: Aug. 13, 2026

(54) SCALED BIT LENGTHS FOR TRAINING NEURAL NETWORKS

(71) Applicant: International Business Machines Corporation, Armonk, NY (US)

(72) Inventors: Bruce Gordon ELMEGREEN, Goldens Bridge, NY (US); MALGORZATA JADWIGA ZIMON, Warrington (GB); Fausto Martelli, Stockton Heath (GB); Kyong Min Yeo, Scarsdale, NY (US)

(21) Appl. No.: 19/051,443

(22) Filed: Feb. 12, 2025

(51) Int. Cl. G06N 3/084; G06N 3/10

(52) U.S. Cl. CPC G06N 3/084; G06N 3/10

(57) ABSTRACT

A method, computer system, and a computer program product are provided. A neural network that includes multiple layers and multiple nodes in each layer is trained with training data. The nodes are sparsely connected to each other and not fully connected. After the training occurs for one or more epochs, a respective flow rate of the multiple nodes is determined. The flow rate indicates a probability that information flows through the respective layer through a respective node of that respective layer. A number of bits used for weights of the nodes is scaled based on the determined flow rates. A larger number of bits is used for the nodes with a larger information flow and a smaller number of bits is used for the nodes with a smaller information flow. Additional training of the neural network is performed using the respective scaled number of bits for the multiple nodes.

### BACKGROUND

The present invention relates generally to the fields of machine learning, neural networks, training neural networks, and processors used to train machine learning models such as a neural network.

### SUMMARY

According to one exemplary embodiment, a computer-implemented method is provided. A neural network that includes multiple layers and multiple nodes in each layer is trained with training data. The nodes are sparsely connected to each other and not fully connected. After the training occurs for one or more epochs, a respective flow rate of the multiple nodes is determined. The flow rate indicates a probability that information flows through the respective layer through a respective node of that respective layer. A number of bits used for weights of the nodes is scaled based on the determined flow rate values. A larger number of bits is used for the nodes with a larger information flow and a smaller number of bits is used for the nodes with a smaller information flow. Additional training of the neural network is performed using the respective scaled number of bits for the multiple nodes. A computer program product and a computer system corresponding to the above method are also disclosed herein.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a process for scaling bit lengths according to information flow rate to facilitate neural network training according to at least one embodiment.

FIG. 2 illustrates details according to at least one embodiment illustrating flow rates of information flowing through nodes of a neural network at a first stage during training.

FIG. 3 illustrates details according to at least one embodiment illustrating flow rates of information flowing through nodes of a neural network at a second stage during training.

FIG. 4 illustrates a processor chip with multiple arithmetic units in which the scaling process of FIG. 1 is carried out according to some embodiments.

FIG. 5 illustrates a system of multiple separate hardware elements in which the scaling process of FIG. 1 is carried out according to some embodiments.

FIG. 6 illustrates the neural network shown in FIGS. 2 and 3 with portions of the neural network broken into sub-networks for separate operation with different bit lengths according to some embodiments.

FIG. 7 illustrates a networked computer environment in which information flow rate to facilitate neural network training is performed according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

Computer systems can be complemented with special-purpose accelerators. One important application of such a solution is the training of a machine learning model such as a neural network (NN) model, e.g., a large NN model. A growing number of artificial neurons and layers in NN architectures encourages leveraging accelerators to speed up the time-consuming optimization. However, there are still many disadvantages in the form of a huge number of power-consuming floating-point operations and large memory requirements to store network parameters.

The present disclosure details a system aimed at adaptive adjustment of numerical precision during neural network training. The present disclosure uses flow rates, e.g., local entropies, of components of a machine learning model to define the memory requirement and the required arithmetic precision for subnetworks of the NN model.

In sparse network designs, the probability of information following a particular path of connections may converge quickly. A sparse neural network topology has been shown to perform well in general learning tasks. Such a neural network consists of multiple layers and nodes, with the nodes not being fully connected, e.g., with each node being connected to at most two other nodes in the adjacent layers. For example, a node A is directly connected to two nodes from a directly preceding layer and is directly connected to two additional nodes in a directly following layer. Because the connection pattern resembles an array of rhombuses, in some instances the neural network is referred to as a rhombus tile neural network RTNN. The sparse connectivity of such a topology allows parts of the NN to be distributed to processing units with different precision.

To enable adaptive precision adjustment, various embodiments of the present disclosure determine a flow rate by using a function that is the logarithm of the product of unity-normalized weights. The fourth node in the second hidden layer (“HL 2”) has four weights/connections (two incoming and two outgoing), while the first node in the second hidden layer has only two weights/connections (one incoming and one outgoing). Also, the whole hidden second layer has nine nodes with sixteen incoming connections from the hidden first layer HL 1 and sixteen outgoing connections to the hidden third layer HL 3. This function is identified as entropy: either the entropy of the layer or the entropy of the node, viewing a unity-normalized weight as the probability that information flows from one point to another. As the weights stabilize during training to non-equal values, the information flow gets more channeled through a few nodes and the layer entropy decreases. In this way, the entropy for the layer is analogous to the entropy of a thermal system, having smaller values for a more confined occupation of phase space and larger values for a more dispersed occupation. The entropy for each node corresponds to the relative importance of that node, as the sum of the respective entropy of each of the nodes in a layer equals the layer entropy for that layer.

Measuring local entropy regarding information flow in the sparse topology facilitates the identification of important information flow through the neural network. This information once obtained is thereafter used to adaptively tune the precision of subnetworks that contain less or more important nodes to reflect their impact on the final model. As the network can be distributed to different processing units, the precision of the entire processor that computes a given sub-model is dynamically adjusted. In some embodiments, using hardware for mixed-precision arithmetic the present disclosure encompasses doing this flowrate-based bit length scaling on a single processor chip for training of the neural network.

In various embodiments one or both of two measures of entropy in a neural network that uses a sparse topology (such as an RTNN) are utilized to determine information flow rate through the neural network. The first measure of entropy in a sparse NN is based on all the weights in a layer and measures the degree of confinement of information flow through the various nodes of the layer. A second measure of entropy in the NN is based on the weights in each node and is used to determine the bit precision of the calculations performed on that node. Desired precision of arithmetic for node calculation is herein a function of such local entropy. Various embodiments include a neural network hardware processor in which the number of bits, used for the arithmetic in a node, scales with the log of the maximum weight for incoming or outgoing data to that node (node-entropy) after some initial adjustment time. The initial adjustment time is achieved after and/or starting when one or both the layer entropies and the node entropies have changed significantly after the start of the training and before one or both of these two entropies reaches equilibrium distributions. The initial adjustment time is typically a small fraction of the total time for the neural network to be trained, which is especially true if the neural network has sparse connectivity for its nodes. The bit accuracy that is provided is high for weights during the initial adjustment time and decreases for the relatively unimportant nodes after this initial training time according to the techniques of the present embodiments.

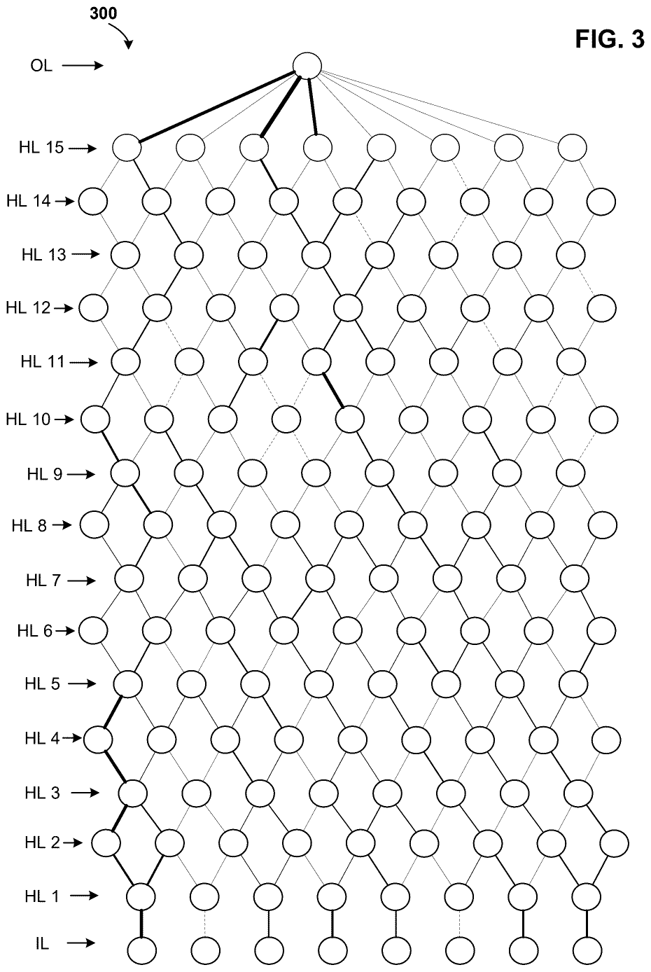

Hyper-uniform networks, such as RTNN, can be applied to different tasks in place of a fully connected counterpart. Lack of information mixing and separation of input influences facilitate the identification of connections with significant information flow. Such topologies highlight where the weights become the largest and where the connections between layers are the strongest. These dominant weights carry the most important correlations and shared information among the input nodes and dominate network training. FIG. 3 shows an RTNN that has been fully trained to recover a piece-wise continuous model,

$${\prod }_{i}^{8} ( {a}_{i} {θ}_{i}^{2} + 1 ) ,$$

with inputs θᵢ for i=1, . . . , 8, where:

$$\{ \begin{matrix}a = [ 1 , 0 , 0 , 0 , 0 , 0 , 1 , 1 ] if {θ}_{1} < 0.5 , \\ a = [ 0 , 0 , 1 , 1 , 1 , 0 , 0 , 0 ] if {θ}_{1} \geq 0.5 .\end{matrix}$$

In the graph, the connection thickness is proportional to the unity-normalized weights. The information flows mostly along tracks with nonzero coefficients, with little use of the second and sixth connections in the input layer “IL” which have essentially no contribution.

In the case of one layer in a NN, the unity-normalized weights for all the incoming data, i.e., from all the nodes in the previous layer, may be viewed as probabilities that the data is flowing through the connecting lines associated with each of those weights. If the weights for incoming data to a particular layer are all equal, then the data flows uniformly into the nodes in the layer. If some unity-normalized weights are much larger than others, then the data flows non-uniformly into the layer with greater representation and importance for the data coming in along connecting lines with higher weights.

This concentration of the information flow through a layer resulting from a spread in the value of the weights is measured in some embodiments with a unique function that scales with the logarithm of the product of the unity-normalized weights for that layer. That is, after dividing each weight by the sum of the weights in its layer, to produce unity-normalized weights, take the log of the product of these for the layer. This function has a maximum value when all the weights are equal, e.g., at the initialized untrained state, and the function decreases to a small value when a few highly contributing weights carry most of the information to the next layer and the rest of the weights in that layer are small. A constant value may be multiplied by this logarithm, and another constant value may be added to this logarithm, both without loss of generality, such as to make the result positive or to limit the result to a maximum positive value. This function is referred to as the entropy of the layer, viewing a unity-normalized weight as the probability that information flows from one layer to the next through that weight. As the weights connecting to a layer stabilize to highly diverse values for all the different nodes in that layer, the layer entropy decreases to a near-constant value.

Similarly, a node entropy is determined with the logarithm of the maximum weight in that node, again allowing for multiplicative factors and additive constants to the log without loss of generality. For a node that has relatively small weights, the nodal entropy will be small, and a small fraction of the information will pass through that node.

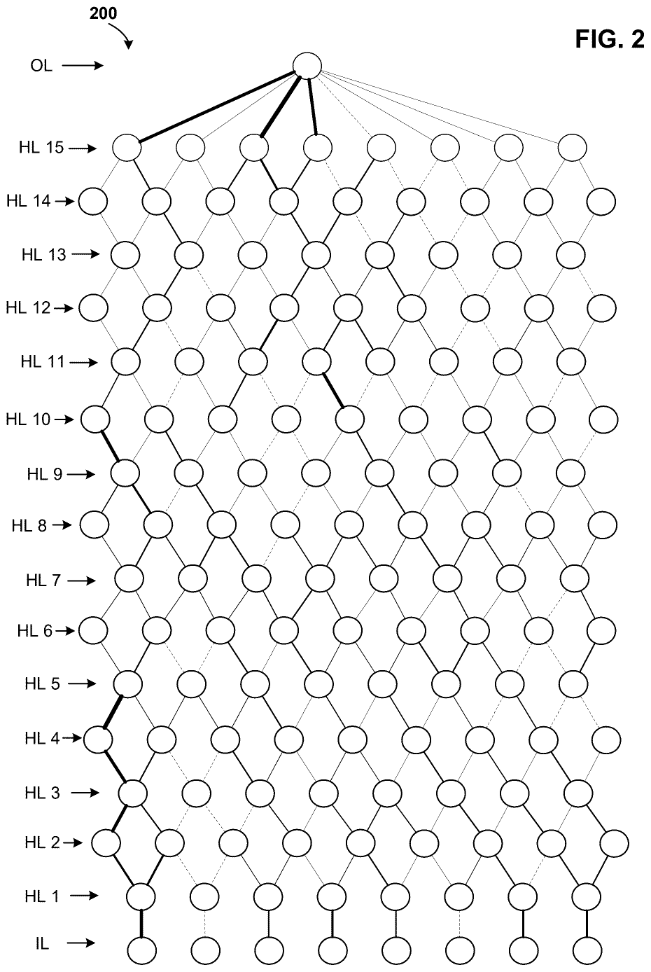

Experiments with RTNN applications show that both the layer entropies and the node entropies adjust rapidly during training and equilibrize to steady values long before the data error moves close to its minimum value. In FIG. 2, the node-rate entropy after only 20 epochs is shown. The distribution of nodes that are high flow or low flow do not change in the training beyond this point, even though the network is still looking for the optimal parameter values at subsequent epochs. This steady distribution means that the correlated components of the input are recognized early in training: the optimization reaches the entropy basin and most of the training time is spent fine-tuning the same dominant weights. Such behavior is not present for fully connected neural networks.

When the information flow is highly non-uniform, there is a possibility for significant energy savings during training if the number of significant figures used for the weighted arithmetic varies with the value of the weight. The value of the weight is a measure of the importance of the weight. It is generally true that in a sequence of arithmetic operations, certain contributions dominate while others contribute only to the least significant figures or are lost in the round-off truncation. The number of bits used for the calculation/arithmetic of a weight are in at least some embodiments proportional to the contribution of that particular node to the result of training without significant loss of accuracy.

This proportion can be established by forcing the number of bits in the arithmetic operations inside a node to scale with the log of the maximum weight in that node. For example, a node with two input connections from the next lower layer in an RTNN will have an adjustable weight for each input. The node will use the two adjustable weights to multiply by the two input values. The node will then sum the two multiplication results. The node also makes a nonlinear transformation of that sum, such as by performing a sigmoid function, before passing the resulting value to the two connected nodes in the next higher layer. The bit precision inside that node should be sufficient to maintain the desired high accuracy of the result in the last layer of the neural network. If the node weights become relatively small during training after normalization to the unity sum in the layer, then this means that the information flowing through that node from the previous two connected nodes in the next-lower layer is relatively unimportant. Those relatively small weights convert the incoming values to near-zero values before passing that information onto the next higher layer. As the weights in a node change during training, the number of bits used for the arithmetic of that node should also change so that smaller values of the maximum normalized weight correspond to fewer bits used for the nodal calculations. The maximum value of the nodal weight is used to determine the bit count in that node, via the logarithmic function as described above, because this maximum weight dominates the arithmetic and has to be most accurately represented in the output of the node. This maximum value is present, depending on the flow within the NN, in either or both of the incoming and outgoing connections.

To avoid startup errors or instabilities, the adjustment of bit accuracy should be delayed until the layer entropies adjust to their equilibrium values, e.g., after one or more epochs of training have already been performed. Although there is still much more training to do after this equilibrium of layer entropies is reached, most of the nodes in the NN operation will operate at highly reduced bit counts.

This reduction in energy consumption assumes the number of bits used in an arithmetic operation can be adjusted, either at the bit or byte rate and that the energy scales with the number of bits. Such bit or byte-wise adjustments are implemented in processor chips, accelerator chips, field programmable gate arrays (FPGAs) and/or other highly flexible chips. IN some embodiments, a processor has fixed numbers of arithmetic units with various bit accuracies, i.e., some with one-byte accuracy, some with two-byte accuracy, and so on, and the weight arithmetic is routed to the arithmetic unit with a number of bytes proportional to the absolute value of the log of the weight.

To ensure sufficiently high accuracy for all the arithmetic operations in a layer, the maximum number of bits in each node of that layer should be a constant value that is as high as the processor performing that node operation will allow. To ensure this maximum number of bits, or to establish a desired range for the number of bits, the logarithm of the maximum weight in a node is multiplied by a constant value and another constant value is added to the logarithm of the maximum weight in the node.

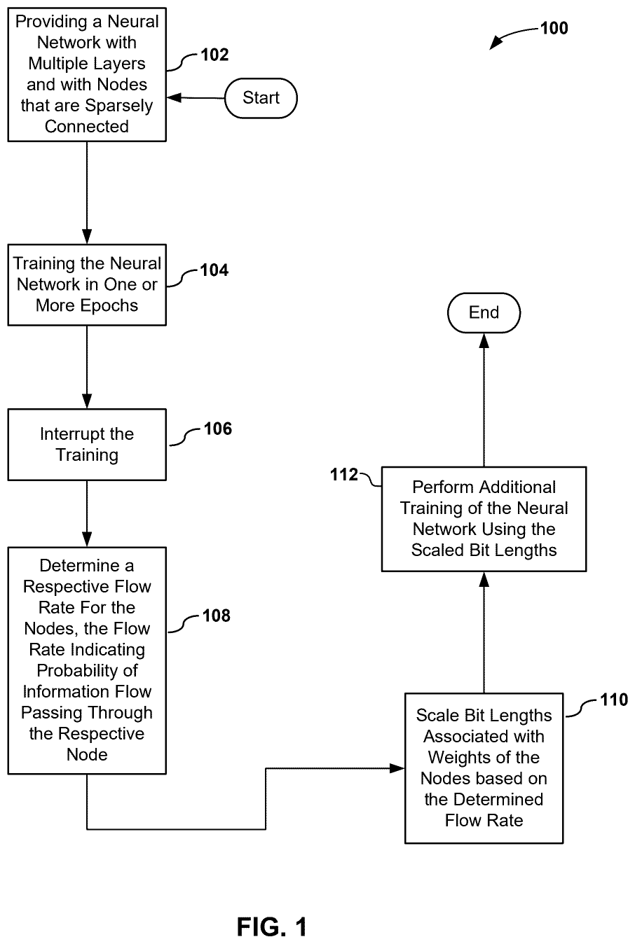

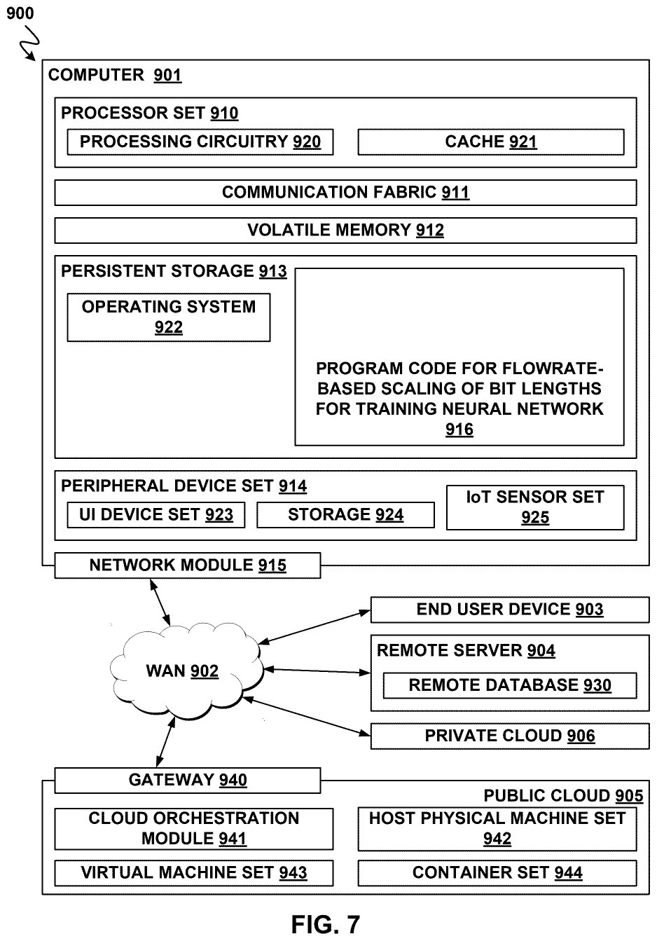

FIG. 1 illustrates a process 100 for flowrate-based scaling of bit lengths for neural network training according to at least one embodiment. This scaling process 100 is in at least some embodiments carried out via program code for flowrate-based scaling of bit lengths for neural network training 916 that is described subsequently and shown in the computing environment 900 of FIG. 7.

In step 102 of the scaling process 100, a neural network with multiple layers and with nodes that are sparsely connected is provided. This step is performed via one or more agents providing an input into program code for flowrate-based scaling of bit lengths for neural network training 916, e.g., via an input device (e.g., keyboard, microphone, touch screen display, etc.) of the computer 901. In some embodiments step 102 is performed via initiation of the program code 916 and the program code 916 in a default state initially proceeds to providing the sparsely connected neural network.

In step 104 of the scaling process 100, the neural network is trained in one or more epochs. This step 104 includes providing training data, e.g., labeled training data, to the neural network that was provided in step 102. A loss is determined by comparing (A) the predicted output of the neural network for that particular input sample to (B) a ground truth answer for that input sample. The ground truth answer in some instances is considered a label for the training data. After the loss is determined, backpropagation is performed on the parameters and/or weights of the nodes and/or layers of the neural network. The backpropagation is based on the loss that was determined.

In step 106 of the scaling process 100, the training of step 104 is interrupted. This interruption occurs after the one or more epochs of training occurred in step 104.

In step 108 of the scaling process 100, a respective flow rate for the nodes is determined. The flow rate indicates the probability of information flow passing through the respective node. The nodes are part of the neural network that was provided in step 102, that was trained in step 104, and whose training was interrupted in step 106.

In at least some embodiments, the flow rate is determined via an entropy determination.

In step 110 of the scaling process 100, bit lengths associated with weights of the nodes are scaled based on the determined flow rate that was determined in step 108. The scaling includes using a larger number of bits for the nodes with a larger information flow and a smaller number of bits for the nodes with a smaller information flow.

In step 112 of the scaling process 100, additional training of the neural network is performed using the scaled bit lengths. In some instances, this additional training occurs via performing node calculations at a separate hardware component or at a separate arithmetic unit within a single processor chip. The hardware component or the arithmetic unit is selected according to the scaling of step 110. This additional training occurs for one or more epochs of training and uses additional training data. This additional training occurs in at least some embodiments until convergence is reached for optimized performance of the neural network. The scaling of the bits occurs during the training, i.e., at a stage when more training to an initial model convergence will subsequently take place. Thus, the scaling of the bits does not occur after the training to model convergence is complete, but rather is done on the fly. Model training is a computationally intense process, so directing node operations to be handled with more bits (for more important nodes that have more information flow) or with less bits (for less important nodes that have less information flow) saves in computation and energy costs for model training.

After the neural network is fully trained, the fully trained neural network is useable to perform a downstream task. For example, the fully trained neural network is used to perform a downstream task of inference. For the inference, a data sample is input into the trained neural network. In response to the inputting, the trained neural network analyzes the input sample and outputs a prediction, e.g., a classification, regarding the input sample.

FIG. 2 shows flow rate values for a first neural network after a first stage of training of the neural network is performed. The initially-trained neural network 200 is shown after receiving twenty epochs of training where the loss value is 0.804886. The initially-trained neural network 200 has nodes that are sparsely connected and not fully connected between the separate layers. This neural network includes an input layer (“IL”), fifteen hidden layers (“HL”), and an output layer (“OL”). The various nodes represented by the circles are mostly directly connected to two nodes from a directly preceding layer and directly connected to two additional nodes in a directly following layer. Admittedly, some of the nodes disposed on the rightmost or leftmost side of the hidden layers with nine nodes have just one incoming connection and one outgoing connection. Because the connection pattern resembles an array of rhombuses, in some instances the initially-trained neural network 200 is referred to as a rhombus tile neural network RTNN. The sparse connectivity of such a topology allows parts of the NN to be distributed to processing units with different precision.

FIG. 3 illustrates details of the neural network shown in FIG. 2, but after additional training has occurred so that FIG. 3 shows a further-trained neural network 300. Some of the weights for connecting paths have changed as compared to the weights of the initially-trained neural network 200 shown in FIG. 2. These changes are due to further adjustment of the node weights/path weights based on using additional training data, determining a loss, and performing backpropagation on the node weights based on the determined loss. The further-trained neural network 300 is shown after receiving fifty epochs of training where the loss value is 0.636164. The loss value for the further-trained neural network 300 being lower than the loss value for the initially-trained neural network 200 shows the training progress that has been made between the additional epochs of training of the sparsely-connected neural network.

In some embodiments, additional model training continues after the fifty epochs are completed. For example, in an embodiment the additional model training continues for a total of one hundred training epochs until the loss is reduced to 0.006041.

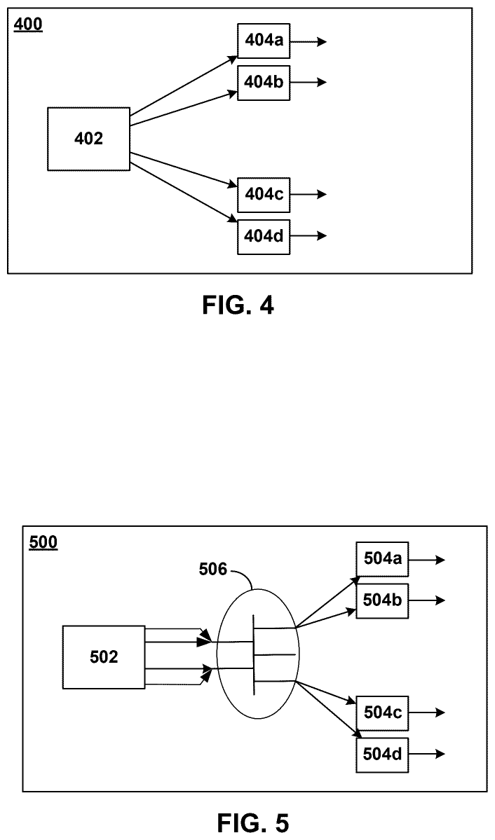

FIG. 4 illustrates a processor chip 400 with multiple arithmetic units 404a, 404b, 404c, 404d in which the scaling process 100 of FIG. 1 is carried out according to some embodiments. The processor chip 400 includes other components that are not shown. A control unit 402 guides node operations to the various arithmetic units 404a, 404b, 404c, 404d based on information flowrate, e.g., information flow entropy, determinations. For example, for node operations having a lowest entropy and values of a flow rate within a highest range, these node operations are transmitted to the first arithmetic unit 404a which operates with a highest number of bits of the various arithmetic units 404a, 404b, 404c, 404d. For node operations having a second lowest entropy and values of a flow rate within a second highest range, these node operations are transmitted to the second arithmetic unit 404b which operates with a second highest number of bits of the various arithmetic units 404a, 404b, 404c, 404d. For node operations having a third highest entropy and values of a flow rate within a second lowest range, these node operations are transmitted to the third arithmetic unit 404c which operates with a third highest number of bits of the various arithmetic units 404a, 404b, 404c, 404d. For node operations having a highest entropy and values of a flow rate within a lowest range, these node operations are transmitted to the fourth arithmetic unit 404d which operates with a lowest number of bits of the various arithmetic units 404a, 404b, 404c, 404d. Thus, the number of bits for the first arithmetic unit 404a is larger than the number of bits for the second arithmetic unit 404b whose number of bits is larger than the number of bits for the third arithmetic unit 404c whose number of bits is larger than the number of bits for the fourth arithmetic unit 404d.

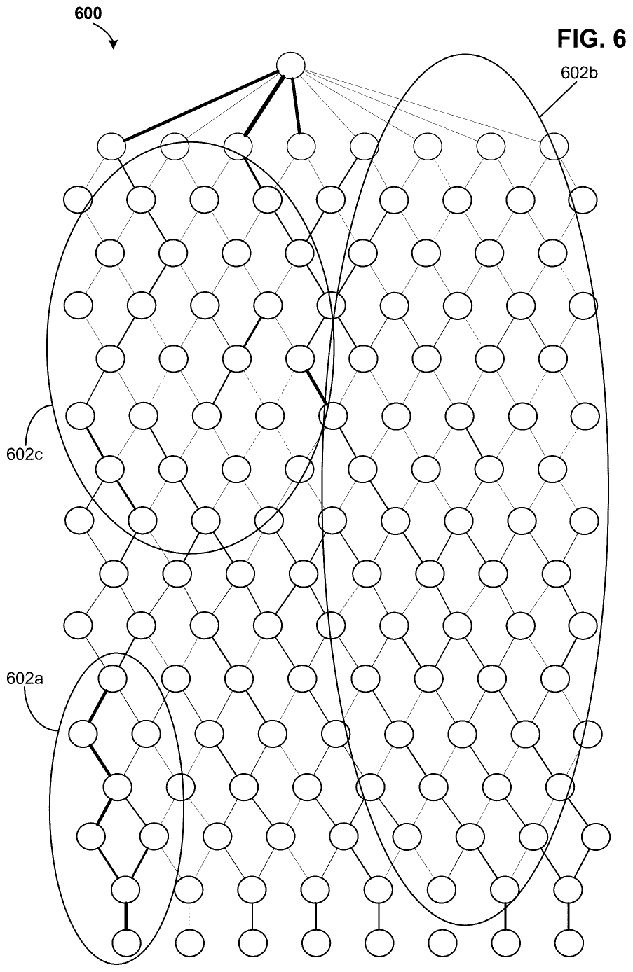

FIG. 5 illustrates a networked system 500 of multiple separate hardware elements 504a, 504b, 504c, 504d in which the scaling process 100 of FIG. 1 is carried out according to some embodiments. The networked system 500 is similar to the processor chip 400 with multiple arithmetic units 404a, 404b, 404c, 404d of FIG. 4, but instead of transmitting differing node operations needing various precision to different elements within the same processor chip, the node operations are transmitted to external hardware computers which operate at different precisions. The networked system 500 includes a leader computer 502 which analyzes the precision needed for a node operation and transmits the node operation through a network 506 to one of the multiple separate hardware elements 504a, 504b, 504c, 504d for performance there of the node operations. The leader computer 502 guides node operations to the various separate hardware elements 504a, 504b, 504c, 504d based on information flowrate, e.g., information flow entropy, determinations. For example, for node operations having a lowest entropy and values of a flow rate within a highest range, these node operations are transmitted to the first hardware computer 504a which operates with a highest number of bits of the various hardware computers 504a, 504b, 504c, 504d. For node operations having a second lowest entropy and values of a flow rate within a second highest range, these node operations are transmitted to the second hardware computer 504b which operates with a second highest number of bits of the various hardware computers 504a, 504b, 504c, 504d. For node operations having a third highest entropy and values of a flow rate within a second lowest range, these node operations are transmitted to the third hardware computer 504c which operates with a third highest number of bits of the various hardware computers 504a, 504b, 504c, 504d. For node operations having a highest entropy and values of a flow rate within a lowest range, these node operations are transmitted to the fourth hardware computer 504d which operates with a lowest number of bits of the various hardware computers 504a, 504b, 504c, 504d. Thus, the number of bits for the first hardware computer 504a is larger than the number of bits for the second hardware computer 504b whose number of bits is larger than the number of bits for the third hardware computer 504c whose number of bits is larger than the number of bits for the fourth hardware computer 504d.

FIG. 6 illustrates the neural network shown in FIGS. 2 and 3 with the neural network appearing as a subdivided neural network 600 which is broken into sub-networks 602a, 602b, 602c for separate operation at processors with different bit lengths according to some embodiments. The first sub-network 602a has a highest rate of information flow, so is sent by the control logic of a processor to a processor which has a highest number of bits that are available, e.g., is sent to the first arithmetic unit 404a in the processor chip shown in FIG. 4 or is sent to the first hardware computer 504a in the networked system 500 shown in FIG. 5. The second sub-network 602b has an intermediate rate of information flow, so is sent by the control logic of a processor to a processor which has an intermediate number of bits that are available, e.g., is sent to the second or third arithmetic unit 404b or 404c in the processor chip shown in FIG. 4 or is sent to the second or third hardware computer 504b or 504c in the networked system 500 shown in FIG. 5. The third sub-network 602c has a lowest rate of information flow, so is sent by the control logic of a processor to a processor which has a lowest number of bits that are available, e.g., is sent to the fourth arithmetic unit 404d in the processor chip shown in FIG. 4 or is sent to the fourth hardware computer 504d in the networked system 500 shown in FIG. 5. In at least some embodiments, the separate sub-networks are separated from each other by one or more nodes that have a flow rate that is a lower than a pre-determined threshold value. In some embodiments, some nodes of the neural network are duplicated and appear in more than one of the separated sub-networks so that an individual sub-network can more easily perform calculations without needing communication with another of the separated sub-networks.

An artificial neural network is a collection of one or more nodes. An artificial neural network is often divided into groups of nodes called layers. A layer is a collection of one or more nodes that all receive input from the same layer(s), and all send output to the same layer(s). The layer(s) from which the one or more nodes all receive input and the layer(s) to which the one or more nodes all send output are the adjacent, or neighboring, layers of the layer. Two nodes between which information flows (e.g., output of one node is sent to and received as input by the other node) are connected. Each connection may have an associated weight.

In some implementations, the associated weight of a connection may characterize the strength of the connection. A layer from which the one or more nodes all receive input is a preceding layer. A node's connection with a node of its preceding layer may be referred to as an incoming connection. A layer to which the one or more nodes all send output may be referred to as a following layer. A node's connection with a node of its following layer may be referred to as an outgoing connection.

An input layer is a layer that receives input from a source outside the artificial neural network. An output layer is a layer that sends output to a target outside the artificial neural network. All other layers are intermediate processing layers (i.e., hidden layers). A multilayer neural network is an artificial neural network with more than one layer. A deep neural network is a multilayer neural network with many layers.

A sparse neural network is an artificial neural network where a node is only connected to some (one or more) but not all nodes of its adjacent layer(s). In sparse neural networks, the information flow from the input layer to the output layer may be isolated and form paths.

A tensor is a multidimensional array of numerical values. A tensor block is a contiguous subarray of the elements in a tensor. Each neural network layer is associated with a parameter tensor V, weight tensor W, input data tensor X, output data tensor Y, and intermediate data tensor Z. The parameter tensor contains all parameters that control node activation functions σ in the layer. The weight tensor contains all weights that connect inputs to the layer. The input data tensor contains all data that the layer consumes as input. The output data tensor contains all data that the layer computes as output. The intermediate data tensor contains any data that the layer produces as intermediate computations, such as partial sums.

The data tensors (input, output, and intermediate) for a layer may be 3-dimensional, where the first two dimensions may be interpreted as encoding spatial location and the third dimension as encoding different features. For example, when a data tensor represents a color image, the first two dimensions encode vertical and horizontal coordinates within the image, and the third dimension encodes the color at each location. Every element of the input data tensor X can be connected to every node by a separate weight, so the weight tensor W generally has 6 dimensions, concatenating the 3 dimensions of the input data tensor (input row a, input column b, input feature c) with the 3 dimensions of the output data tensor (output row i, output column j, output feature k). The intermediate data tensor Z has the same shape as the output data tensor Y.

The parameter tensor V concatenates the 3 output data tensor dimensions with an additional dimension o that indexes the parameters of the activation function σ. In some embodiments, activation function σ requires no additional parameters, in which case the additional dimension is unnecessary. However, in some embodiments, activation function σ requires at least one additional parameter, which appears in dimension o. The activation function may be a linear activation function or a non-linear activation function. Activation functions that may be used by an artificial neural network as described herein may comprise sigmoid, tanh, ReLU, leaky ReLU, parametric ReLU, Softmax, and/or other activation functions. For example, an artificial neural network as described herein may have a tanh activation function.

An element of a layer's output data tensor Y can be computed as in Equation 1 where the node activation function σ is configured by the vector of activation function parameters V[i, j, k, :], and the weighted sum Z[i, j, k] can be computed as in Equation 2.

$$Y [ i , j , k ] = σ ( V [ i , j , k , : ] ; Z [ i , j , k ] ) \qquad ( Eqn . 1 )$$

$$Z [ i , j , k ] = {\sum }_{a = 1}^{A} {\sum }_{b = 1}^{B} {\sum }_{c = 1}^{C} W [ i , j , k , a , b , c ] \cdot X [ a , b , c ] \qquad ( Eqn . 2 )$$

For simplicity of notation, the weighted sum in Equation 2 may be referred to as the output, which is equivalent to using a linear activation function Y[i, j, k]=ø(Z[i, j, k])=Z[i, j, k], with the understanding that the same statements apply without loss of generality when a different activation function is used.

It will be apparent from the above that neural networks are parallel structures. Nodes in a given layer receive inputs, X with elements xᵢ, from one or more layers or other inputs. Each node computes its state, y∈Y based on the inputs and weights W with elements wᵢ. In various embodiments, the weighted sum of inputs is adjusted by a bias b, and then the result is passed to a nonlinearity F(⋅). For example, a single node activation may be expressed as y=F(b+Σxᵢwᵢ).

An artificial neural network may be trained to solve a specific problem (e.g., pattern recognition) or to make a particular inference such as a classification by adjusting the weights of the connections such that a particular class of inputs produce a desired output. Various algorithms may be used for this learning process. Certain algorithms may be suitable for specific tasks such as image recognition, speech recognition, or language processing. Training algorithms lead to a pattern of weights that, during the learning process, converge toward an optimal solution to the given problem. The goal of such learning is to obtain a system that generalizes data unavailable during training.

Determining the information flow rate within a neural network that is being trained includes in some embodiments normalizing each weight of an artificial neural network. The artificial neural network may comprise a plurality of nodes. The nodes may be organized into a plurality of layers. Each of the plurality of nodes may be connected to at least one node of at least one adjacent layer. Each connection may have an associated weight. The normalization of each weight may comprise determining a min-max normalized value of each weight.

Suitable artificial neural networks include but are not limited to a feed-forward neural network, a radial basis function network, a self-organizing map, learning vector quantization, a recurrent neural network, a Hopfield network, a Boltzmann machine, an echo state network, long short term memory, a bi-directional recurrent neural network, a hierarchical recurrent neural network, a stochastic neural network, a modular neural network, an associative neural network, a deep neural network, a deep belief network, a convolutional neural networks, a convolutional deep belief network, a large memory storage and retrieval neural network, a deep Boltzmann machine, a deep stacking network, a tensor deep stacking network, a spike and slab restricted Boltzmann machine, a compound hierarchical-deep model, a deep coding network, a multilayer kernel machine, or a deep Q-network.

In some implementations, the artificial neural network is a feed-forward neural network. The plurality of layers may comprise an input layer, an output layer, and at least one hidden layer. In some implementations, each node of the at least one hidden layer has at most four connections. In some implementations, each node of the input layer has at most one connection. In some implementations, each node of the output layer has at most as many connections as the number of nodes in the preceding layer.

The determining of the information flow rate in at least some embodiments further includes determining an entropy value, e.g., an information flow entropy value, for each node in the artificial neural network based on the weights of that node's connections. The entropy value for a node may characterize a magnitude of information carried by the node. The information may be relevant to generation of an output by the artificial neural network. Determining an entropy value for a node of the artificial neural network may comprise determining the product of the normalized weights for all connections of the node. Determining the entropy value may comprise determining the logarithm of the product. Determining the entropy value may comprise determining the absolute value of the logarithm. For example, the entropy value for each node nₗ in layer l, may be represented by taking the normalized Nₙ_{ₗ} weights of incoming and outgoing connections,

$${w}_{i}^{{n}_{i}} ,$$

and computing the absolute value of the logarithm of their product. For example, the entropy value of a node can be represented as follows:

$$\vert log ( {\prod }_{i = 1}^{{N}_{{n}_{1}}} {w}_{i}^{{n}_{1}} ) \vert$$

In at least some embodiments, the determination of the information flow rate includes the normalization of each node weight which itself includes determining a min-max normalized value of each nodal weight.

It may be appreciated that FIGS. 1-6 provide only illustrations of certain embodiments and do not imply any limitations with regard to how different embodiments may be implemented. Many modifications to the depicted embodiment(s), e.g., to particular processor or network implementations or steps, elements, and/or order of depicted methods or components of guiding node operations based on design and implementation requirements.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 900 in FIG. 7 contains an example of an environment for the execution of at least some of the computer code involved in performing the inventive methods, such as program code for flowrate-based scaling of bit lengths for neural network training 916. In addition to program code for flowrate-based scaling of bit lengths for neural network training 916, computing environment 900 includes, for example, computer 901, wide area network (WAN) 902, end user device (EUD) 903, remote server 904, public cloud 905, and private cloud 906. In this embodiment, computer 901 includes processor set 910 (including processing circuitry 920 and cache 921), communication fabric 911, volatile memory 912, persistent storage 913 (including operating system 922 and program code for flow-rate based scaling of bit lengths for neural network training 916, as identified above), peripheral device set 914 (including user interface (UI) device set 923, storage 924, and Internet of Things (IoT) sensor set 925), and network module 915. Remote server 904 includes remote database 930. Public cloud 905 includes gateway 940, cloud orchestration module 941, host physical machine set 942, virtual machine set 943, and container set 944.

COMPUTER 901 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 930. As is well understood in the art of computer technology, and depending upon the technology, performance of a computer-implemented method may be distributed among multiple computers and/or between multiple locations. On the other hand, in this presentation of computing environment 900, detailed discussion is focused on a single computer, specifically computer 901, to keep the presentation as simple as possible. Computer 901 may be located in a cloud, even though it is not shown in a cloud in FIG. 7. On the other hand, computer 901 is not required to be in a cloud except to any extent as may be affirmatively indicated.

PROCESSOR SET 910 includes one, or more, computer processors of any type now known or to be developed in the future. Processing circuitry 920 may be distributed over multiple packages, for example, multiple, coordinated integrated circuit chips. Processing circuitry 920 may implement multiple processor threads and/or multiple processor cores. Cache 921 is memory that is located in the processor chip package(s) and is typically used for data or code that should be available for rapid access by the threads or cores running on processor set 910. Cache memories are typically organized into multiple rates depending upon relative proximity to the processing circuitry. Alternatively, some, or all, of the cache for the processor set may be located “off chip.” In some computing environments, processor set 910 may be designed for working with qubits and performing quantum computing.

Computer readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 921 and the other storage media discussed below. The program instructions, and associated data, are accessed by processor set 910 to control and direct performance of the inventive methods. In computing environment 900, at least some of the instructions for performing the inventive methods may be stored in program code for flowrate-based scaling of bit lengths for neural network training 916 in persistent storage 913.

COMMUNICATION FABRIC 911 is the signal conduction path that allows the various components of computer 901 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 912 is any type of volatile memory now known or to be developed in the future. Examples include dynamic type random access memory (RAM) or static type RAM. Typically, volatile memory 912 is characterized by random access, but this is not required unless affirmatively indicated. In computer 901, the volatile memory 912 is located in a single package and is internal to computer 901, but, alternatively or additionally, the volatile memory may be distributed over multiple packages and/or located externally with respect to computer 901.

PERSISTENT STORAGE 913 is any form of non-volatile storage for computers that is now known or to be developed in the future. The non-volatility of this storage means that the stored data is maintained regardless of whether power is being supplied to computer 901 and/or directly to persistent storage 913. Persistent storage 913 may be a read only memory (ROM), but typically at least a portion of the persistent storage allows writing of data, deletion of data and re-writing of data. Some familiar forms of persistent storage include magnetic disks and solid state storage devices. Operating system 922 may take several forms, such as various known proprietary operating systems or open source Portable Operating System Interface-type operating systems that employ a kernel. The code included in model-generated code evaluation with program code for flowrate-based scaling of bit lengths for neural network training 916 typically includes at least some of the computer code involved in performing the inventive methods.

PERIPHERAL DEVICE SET 914 includes the set of peripheral devices of computer 901. Data communication connections between the peripheral devices and the other components of computer 901 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 923 may include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 may be persistent and/or volatile. In some embodiments, storage 924 may take the form of a quantum computing storage device for storing data in the form of qubits. In embodiments where computer 901 is required to have a large amount of storage (for example, where computer 901 locally stores and manages a large database) then this storage may be provided by peripheral storage devices designed for storing exceptionally large amounts of data, such as a storage area network (SAN) that is shared by multiple, geographically distributed computers. IoT sensor set 925 is made up of sensors that can be used in Internet of Things applications. For example, one sensor may be a thermometer and another sensor may be a motion detector.

NETWORK MODULE 915 is the collection of computer software, hardware, and firmware that allows computer 901 to communicate with other computers through WAN 902. Network module 915 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 915 are performed on the same physical hardware device. In other embodiments (for example, embodiments that utilize software-defined networking (SDN)), the control functions and the forwarding functions of network module 915 are performed on physically separate devices, such that the control functions manage several different network hardware devices. Computer readable program instructions for performing the inventive methods can typically be downloaded to computer 901 from an external computer or external storage device through a network adapter card or network interface included in network module 915.

WAN 902 is any wide area network (for example, the internet) capable of communicating computer data over non-local distances by any technology for communicating computer data, now known or to be developed in the future. In some embodiments, the WAN 902 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 903 is any computer system that is used and controlled by an end user (for example, a customer of an enterprise that operates computer 901) and may take any of the forms discussed above in connection with computer 901. EUD 903 typically receives helpful and useful data from the operations of computer 901. For example, in a hypothetical case where computer 901 is designed to provide a recommendation to an end user, this recommendation would typically be communicated from network module 915 of computer 901 through WAN 902 to EUD 903. In this way, EUD 903 can display, or otherwise present, the recommendation to an end user. In some embodiments, EUD 903 may be a client device, such as thin client, heavy client, mainframe computer, desktop computer and so on.

REMOTE SERVER 904 is any computer system that serves at least some data and/or functionality to computer 901. Remote server 904 may be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data may be provided to computer 901 from remote database 930 of remote server 904.

PUBLIC CLOUD 905 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 905 is performed by the computer hardware and/or software of cloud orchestration module 941. The computing resources provided by public cloud 905 are typically implemented by virtual computing environments that run on various computers making up the computers of host physical machine set 942, which is the universe of physical computers in and/or available to public cloud 905. The virtual computing environments (VCEs) typically take the form of virtual machines from virtual machine set 943 and/or containers from container set 944. It is understood that these VCEs may be stored as images and may be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware, and firmware that allows public cloud 905 to communicate through WAN 902.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-rate virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 906 is similar to public cloud 905, except that the computing resources are only available for use by a single enterprise. While private cloud 906 is depicted as being in communication with WAN 902, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 905 and private cloud 906 are both part of a larger hybrid cloud.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

The flowchart and block diagrams in the Figures illustrate the architecture, functionality, and operation of possible implementations of systems, methods, and computer program products according to various embodiments. In this regard, each block in the flowchart, pipeline, and/or block diagrams may represent a module, segment, or portion of instructions, which comprises one or more executable instructions for implementing the specified logical function(s).

What is claimed is:

1. A method comprising:
training, with training data, a neural network comprising multiple layers and multiple nodes in each layer, wherein the nodes are sparsely connected to each other and not fully connected;
after the training occurs for one or more epochs, determining a respective flow rate of the multiple nodes, the flow rate indicating a probability that information flows through the respective layer through a respective node of that respective layer;
scaling a number of bits used for weights of the nodes based on the determined flow rates, wherein the scaling comprises using a larger number of bits for the nodes with a larger information flow and a smaller number of bits for the nodes with a smaller information flow; and
performing additional training of the neural network using the respective scaled number of bits for the multiple nodes.

2. The method of claim 1, wherein the nodes being sparsely connected comprises each of the nodes being connected to at most two respective nodes of an adjacent layer of the layers.

3. The method of claim 1, wherein a processor that performs the method includes multiple arithmetic units, wherein each of the multiple arithmetic units includes a respective bit accuracy that is different from the bit accuracies of the others of the multiple arithmetic units; and
wherein the scaling comprises routing a calculation for a respective node of the nodes to a respective one of the multiple arithmetic units based on the respective determined flow rate.

4. The method of claim 1, further comprising:
identifying, based on the determined flow rate, separate sub-networks within the neural network, wherein the sub-networks are separated from each other by one or more nodes that have the flow rate that is a lower than a pre-determined threshold value; and
training, with additional training data, the separate sub-networks separately from each other using a respective different hardware computer per sub-network.

5. The method of claim 4, wherein the different hardware computers implement a respectively different precision for the training with the additional training data.

6. The method of claim 1, wherein the additional training comprises determining a loss and performing backpropagation based on the loss, wherein the backpropagation adjusts weights of the multiple nodes of the neural network.

7. The method of claim 1, wherein the determined flow rate is based on a respective maximum value of weights of the respective node.

8. The method of claim 7, wherein the respective maximum value is from incoming connections to the respective node and/or from outgoing connections to the respective node.

9. A computer program product comprising:
one or more computer-readable storage media; and
program instructions stored on the one or more storage media to perform operations comprising:
training, with training data, a neural network comprising multiple layers and multiple nodes in each layer, wherein the nodes are sparsely connected to each other and not fully connected;
after the training occurs for one or more epochs, determining a respective flow rate of the multiple nodes, the flow rate indicating a probability that information flows through the respective layer through a respective node of that respective layer;
scaling a number of bits used for weights of the nodes based on the determined flow rates, wherein the scaling comprises using a larger number of bits for the nodes with a larger information flow and a smaller number of bits for the nodes with a smaller information flow; and
performing additional training of the neural network using the respective scaled number of bits for the multiple nodes.

10. The computer program product of claim 9, wherein the nodes being sparsely connected comprises each of the nodes being connected to at most two respective nodes of an adjacent layer of the layers.

11. The computer program product of claim 9, wherein a processor that performs the operations includes multiple arithmetic units, wherein each of the multiple arithmetic units includes a respective bit accuracy that is different from the bit accuracies of the others of the multiple arithmetic units; and
wherein the scaling comprises routing a calculation for a respective node of the nodes to a respective one of the multiple arithmetic units based on the respective determined flow rate.

12. The computer program product of claim 9, wherein the operations further comprise:
identifying, based on the determined flow rate, separate sub-networks within the neural network, wherein the sub-networks are separated from each other by one or more nodes that have the flow rate that is a lower than a pre-determined threshold value; and
training, with additional training data, the separate sub-networks separately from each other using a respective different hardware computer per sub-network.

13. The computer program product of claim 12, wherein the different hardware computers implement a respectively different precision for the training with the additional training data.

14. The computer program product of claim 13, wherein the additional training comprises determining a loss and performing backpropagation based on the loss, wherein the backpropagation adjusts weights of the multiple nodes of the neural network.

15. The computer program product of claim 9, wherein the determined flow rate is based on a respective maximum value of weights of the respective node.

16. The computer program product of claim 15, wherein the respective maximum value is from incoming connections to the respective node and/or from outgoing connections to the respective node.

17. A computer system comprising:
a processor set;
a set of one or more computer-readable storage media; and
program instructions, collectively stored on the set of one or more storage media, for execution by the processor set to cause computer operations comprising:
training, with training data, a neural network comprising multiple layers and multiple nodes in each layer, wherein the nodes are sparsely connected to each other and not fully connected;
after the training occurs for one or more epochs, determining a respective flow rate of the multiple nodes, the flow rate indicating a probability that information flows through the respective layer through a respective node of that respective layer;
scaling a number of bits used for weights of the nodes based on the determined flow rates, wherein the scaling comprises using a larger number of bits for the nodes with a larger information flow and a smaller number of bits for the nodes with a smaller information flow; and
performing additional training of the neural network using the respective scaled number of bits for the multiple nodes.

18. The computer system of claim 17, wherein the nodes being sparsely connected comprises each of the nodes being connected to at most two respective nodes of an adjacent layer of the layers.

19. The computer system of claim 17, wherein the processor set includes multiple arithmetic units, wherein each of the multiple arithmetic units includes a respective bit accuracy that is different from the bit accuracies of the others of the multiple arithmetic units; and
wherein the scaling comprises routing a calculation for a respective node of the nodes to a respective one of the multiple arithmetic units based on the respective determined flow rate.

20. The computer system of claim 17, wherein the operations further comprise:
identifying, based on the determined flow rate, separate sub-networks within the neural network, wherein the sub-networks are separated from each other by one or more nodes that have the flow rate that is a lower than a pre-determined threshold value; and
training, with additional training data, the separate sub-networks separately from each other using a respective different hardware computer per sub-network.
